(19) United States
(12) Patent Application Publication
(10) Pub. No.: US 2026/0364907 A1
(43) Pub. Date: Nov. 19, 2026

(54) MANUFACTURING PLANT FOR PRODUCING SEPARATED STRIP-LIKE LAMINATE COMPONENTS CONTAINING AN ELECTRONIC COMPONENT EMBEDDED BETWEEN TWO LAMINATE LAYERS OF A TAPE-LIKE MATERIAL, METHOD FOR MONITORING SUCH A MANUFACTURING PLANT, COMPUTER PROGRAM, AND ELECTRONICALLY READABLE DATA CARRIER

(71) Applicant: Fischer TireTech Germany GmbH, Burgkunstadt (DE)

(72) Inventor: Frank SCHMIDT, Thurnau (DE)

(21) Appl. No.: 19/673,927

(22) Filed: May 11, 2026

(30) Foreign Application Priority Data
May 15, 2025 (DE) 10 2025 118 821.1

(51) Int. Cl. B29D 30/00

(52) U.S. Cl. CPC B29D 30/0061; B29D 2030/0077

(57) ABSTRACT

A manufacturing plant for producing separated strip-like laminate components containing an electronic component embedded between two laminate layers of a tape-like material. The manufacturing plant has a plurality of material-processing and/or material-conveying manufacturing components controlled based on operating parameters, a control device for controlling the manufacturing components, and an operating device. The control device has a monitoring device for monitoring operation of a manufacturing component to be monitored from among the manufacturing components, including a component for carrying out individual steps of a cycle for acting on the material. A cycle time recording device is provided on the monitored manufacturing component for recording a cycle time. The monitoring device has: a monitoring unit for evaluating cycle times recorded by the cycle time recording device with regard to the fulfilment of at least one measure condition which indicates presence of an anomaly in the manufacturing process, and a measure unit for carrying out a control measure assigned to a fulfilled measure condition and relates to an output of an indication of the presence of the corresponding anomaly and/or an intervention in the manufacturing process related to the anomaly.

### CROSS-REFERENCE TO RELATED APPLICATIONS

The present application claims priority of DE 10 2025 118 821.1, filed May 15, 2025, the priority of this application is hereby claimed, and this application is incorporated herein by reference.

### BACKGROUND OF THE INVENTION

The invention relates to a manufacturing plant for producing separated strip-like laminate components containing an electronic component embedded between two laminate layers of a tape-like material, in particular a rubberized material, having a plurality of material-processing and/or material-conveying manufacturing components which can be controlled on the basis of operating parameters, a control device for controlling the manufacturing components, and an operating device, wherein the control device has a monitoring device for monitoring the operation of at least one manufacturing component to be monitored from among the manufacturing components, comprising at least one individual-step component for carrying out individual steps of a cycle for acting on the material. In addition, the invention relates to a computer-implemented method for monitoring such a manufacturing plant, to a computer program and to an electronically readable data carrier.

Manufacturing plants in which two laminate layers of a tape-like material, in particular a rubberized material, and electronic components for producing separated strip-like laminate components, in which the electronic component is embedded, are processed are known in principle in the prior art. The electronic components are often RFID chips which can be used for identification purposes, for example in the tire industry. In such a case, such a manufacturing plant can also be referred to as an RFID laminating plant. The manufacturing plant may also be understood generally as a machine or device for producing laminate components, in particular in the tire industry. The laminate component thus forms the manufacturing product.

For example, the laminate component can be arranged as a narrow strip on an object or integrated therein. The material tape in the laminate tape serves as a carrier for the electronic component. The material tape is in particular a flexible tape material made of plastic, preferably of a rubberized material, this being understood to mean industrially manufactured elastomers. Depending on the material, it may also be tacky. The electronic component can be any component that can interact in any way with an external detection device. In particular, the component can be an RFID chip on which defined information can be stored, which information can then be read out on the respective object equipped with the RFID chip, for identification purposes, for example to identify it.

An important field of application for such laminate components is the tire industry. As a result of such a laminate component being integrated into the tire during production, each individual tire is provided individually with such an identification element, that is to say for example an RFID chip, so that it can be identified. Corresponding information regarding the production date, the production batch, the permissible filling pressure, etc. can be stored on the RFID chip, for example, and read out as required. Applications in other fields are of course also conceivable.

For the production of such laminate component strips, it is known to first produce an endless laminate tape with the embedded components. For this purpose, the separated components, for example RFID chips, are placed on a tape-like, lower, first laminate layer made of the described material at defined intervals using a placement device. The first laminate layer is moved in a defined conveying direction via a transport means. A tape-like, upper, second laminate layer which is likewise moved in the conveying direction is then placed on this first laminate layer, which is fitted with the components, so that the components are embedded and a laminate tape is formed. The result is, accordingly, a sandwich tape, that is to say a two-layer rubberized laminate tape, whose individual layers can ultimately no longer be separated because of their adhesion or tackiness.

It is then necessary to cut off individual strips from this endless material tape as laminate components, wherein each strip has at least one component. Here, very narrow strips need to be cut, for example with a strip width in the range of a few millimeters, for example approximately 8-12 mm. A cutting device which is suitable in particular for cutting such a laminate tape is known, for example, from DE 20 2021 101 889 U1. This cutting device comprises a gripper device which is designed in such a way that it fixes the material tape during the cut on the table of the cutting device, against which table the cutting blade is moved. If the cutting blade moves down, the laminate strip containing the at least one component is cut. After the cutting blade has moved up again, the gripper device picks up the cut laminate strip and transports it away. The laminate tape is fed to the cutting device in the cutting area via clocked feed operation of the transport means, that is to say, for each individual cutting process, the laminate tape is transported in the conveying direction by a defined distance or travel which corresponds to the desired cutting length.

An exemplary overall manufacturing plant for such laminate components is described by DE 10 2022 124 337 A1.

The description of a manufacturing product that is to be manufactured in a manufacturing process by way of such a manufacturing plant is specified by an operating parameter set of operating parameters that are unchangeable for this manufacturing process, which is usually referred to as a recipe or MES. In addition to a general recipe identification (recipe ID), a recipe may for example comprise the materials and the desired width of the strips to be cut off as laminate components. A recipe is thus described mainly by the requirements placed on the manufacturing product, and is independent of the specific manufacturing plant. However, it may contain requirements placed on the manufacturing speed and/or the output, that is to say the quantity produced per unit of time.

Generally speaking, if a problem occurs during the production of laminate components, for example a malfunction, damage and/or wear to a manufacturing component, restricted sensor data acquisition, a control error or the like, various undesired effects may occur. While in less problematic cases the output may be significantly reduced, for example, such deviations from the proper course of a manufacturing process frequently also lead to production of rejects or in rare cases even to, possibly further, damage to a manufacturing component. It is therefore known for a user to monitor the operation of manufacturing plants regularly or permanently during a manufacturing process, possibly assisted by sensor systems that can detect deviations from the desired manufacturing result, for example. A fine setting and optimization of the manufacturing process take place by means of visual observation by a user, and consequently in a user-dependent manner, since perception often varies. For many adaptations of operating parameters, the manufacturing plants have to be shut down, which also applies to checking in the event of potential problems. Accurate manual recording during the manufacturing process proves to be difficult. In addition, the different interplay and the optimization of individual components on account of frequent recipe changes, i.e. changes in the product to be manufactured, are extremely varied. Therefore, early detection of deviations during the manufacturing process by the user is additionally made more difficult. Predictive maintenance is not possible.

In manufacturing plants for laminate components, as described, provision is made in particular for the material tape to be advanced in a clocked manner by the respective strip width, that is to say to be transported into the area of the cutting apparatus. The strip section width of the laminate components is in the range of a few millimeters, for example approximately 8 to 12 mm. This means that the clocking in this respect is very low. In contrast, a high processing cycle (high output in a short time) is desired in such manufacturing plants. The monitoring of this complex interaction is just as complex. In addition, although the supplied electronic components, in particular RFID chips, may be of different design, they are generally very valuable or expensive. This is another reason to minimize waste in production.

### SUMMARY OF THE INVENTION

The invention is therefore based on the object of specifying easily implementable, highly accurate and robust monitoring of the operation of a manufacturing plant for laminate components with embedded electronic components.

In order to achieve this object, in a manufacturing plant of the type mentioned in the introduction, provision is made according to the invention for at least one cycle time recording means for recording a cycle time of the cycle to be provided on the manufacturing component to be monitored, and for the monitoring device to have:
a monitoring unit for evaluating cycle times recorded by the cycle time recording means with regard to the fulfilment of at least one measure condition which indicates the presence of an anomaly in the manufacturing process, and
a measure unit for carrying out at least one control measure which is assigned to a fulfilled measure condition and relates to an output of an indication of the presence of the corresponding anomaly and/or an intervention in the manufacturing process related to the anomaly.

The operation of the manufacturing plant during the manufacturing process is described by operating parameters, wherein fixed and settable operating parameters are usually present. The attribute “settable” for operating parameters is understood here to mean that the value of the operating parameter may be changed during the manufacturing process of a specific manufacturing product, that is to say a laminate component, able to be described by default parameters. These are in particular operating parameters that are able to be set within what is known as a recipe. A recipe basically comprises operating parameters that are independent of the specific manufacturing plant and at least describe the manufacturing product (i.e. comprise the default parameters) and may optionally additionally describe production conditions, for example a desired output. Typical default parameters may comprise for example a width of the laminate component, a general material specification and/or a type of electronic component, in particular an RFID chip. Some of the operating parameters of a recipe may also be combined as a recipe ID.

Operating parameters that define the recipe or would change it if changed cannot be modified during the manufacturing process for the manufacturing product, i.e. during the implementation of the recipe. The operating parameters of the recipe are provided, for example in a recipe dataset, at the start of the manufacturing process, for example loaded and/or entered from a data carrier and/or server. The operating parameters of a recipe, or generally operating parameters that cannot be changed during a manufacturing process, may be understood to be (some of the) manufacturing conditions or describe same.

A settable operating parameter does not directly have to be a control parameter (for example to be converted into control signals). On the contrary, more abstract settable operating parameters are also conceivable, from which the control device derives at least one, possibly also multiple, control parameters. In particular, the more abstract settable operating parameter may be more intuitively comprehensible to the operator, for example specify a correction that is then achieved specifically by one or more control parameters.

According to the invention, it is proposed to monitor manufacturing processes by means of cycle times which are recorded by means of at least one cycle time recording means. The cycle time recording means can in particular form part of the control device and evaluate control signals exchanged between control units and/or functional units of the control device, for example. Particularly preferably, the control device is configured as a central control device for controlling the entire manufacturing plant, i.e. as a superordinate control entity. Particularly preferably, the monitoring also relates to multiple or even all manufacturing components.

Cycle times are thus recorded by means of control signals, preferably with an accuracy in the millisecond range, for example with an accuracy of at least 10 to 1 ms. By evaluating the cycle times in measure conditions, which particularly advantageously refer to known values from previous and/or optimized manufacturing processes, in particular draw a comparison therewith, deviations or anomalies in the current manufacturing process, as investigations in the context of the present invention have shown, can be detected particularly robustly, accurately and at an early stage. This kind of monitoring on the basis of the cycle times may also be understood as a self-diagnosis of the manufacturing plant. Deviations or anomalies are detected at an early stage and can be brought to the attention of the user, for example an operator, on the basis of the control measures and/or can be alleviated, in particular in a corrective manner, on the basis of the control measures, whether by compensation of the deviations, protection of manufacturing components or their individual-step components (for example by premature termination of the manufacturing process) and the like. Indications of the presence of the corresponding anomaly, in particular warning indications, can be output for example on output means of the operating device, for example by activating a signal lamp and/or warning indications in a user interface for control purposes.

The cycle times are preferably evaluated at least substantially in real time, i.e. with their presence, by the measure condition(s), such that a decision about a control measure to be carried out can be made promptly.

At least one of the at least one measure condition can also use a trained evaluation function of artificial intelligence, in particular when assessing more complex issues. Fundamentally known techniques of machine learning can be used in this case.

It has therefore been recognized, in general terms, that during the production of laminate components in which an electronic component is arranged between a first and a second laminate layer and a laminate strip is cut, a particularly large number of individual-step components of the manufacturing components and also the manufacturing components interact in a coordinated manner among one another highly accurately in a wide variety of ways, depending on the recipe, wherein cycle times, in particular with regard to the individual steps (substeps), which will be discussed in even more detail, react sensitively to deviations and can thus indicate them in a highly accurate and reliable manner. In particular, localization of the deviation is even possible in this way. In particular, the interplay between placement of the electronic component, feed, cut and gripping is essential in this case.

In one expedient development, provision can be made for at least one further recording means to be provided for recording at least one further manufacturing value describing the operation of the manufacturing plant, wherein at least one of the at least one measure condition additionally evaluates at least one of the at least one manufacturing value. By way of example, at least one of the at least one further manufacturing value can relate to a movement and/or a position of the processed material and/or the processed material itself and/or at least one processing condition, in particular a temperature. By way of example, recording means can comprise at least one sensor, but can also interrogate information internally within the control device. At least one of the at least one manufacturing value can also be an operating parameter, for example a default parameter of a current recipe and/or a settable operating parameter.

It is therefore conceivable to also additionally include other manufacturing values of the manufacturing plant in the monitoring process. While in principle measure conditions which relate only to at least one manufacturing value and serve for monitoring are (additionally) conceivable, it may also be expedient to evaluate at least one manufacturing value and at least one cycle time jointly by means of a measure condition. If, for example, it is known that the cutting process takes longer for some materials, this can be mapped against a specific manufacturing value when evaluating the measure condition. Known temperature dependences can also be mapped in measure conditions, for example, if a corresponding manufacturing value is additionally included. In this regard, manufacturing values allow an even more accurate analysis.

In this context, provision can be made particularly advantageously for the recording of the at least one cycle time and the at least one measure condition to be related to a recipe-forming set of operating parameters of the manufacturing plant defined for the manufacturing process. In other words, the monitoring can be carried out in a recipe-specific manner, such that in particular measure conditions can be related to manufacturing processes according to a specific recipe. This consideration of descriptions of a current manufacturing process allows once again significantly more accurate and more robust detection of deviations, i.e. anomalies, in the manufacturing process. By way of example, the control device can have a database in which it is possible to store, in a manner assigned to each recipe, which cycle times are to be recorded and/or which measure conditions are to be used and/or how these are to be parameterized.

In an expedient development of the present invention, provision can be made for the cycle time recording means to be configured, for the purpose of recording the cycle time, to interrogate two successive control signals, in particular readiness and/or trigger signals, of the at least one individual-step component and/or of the manufacturing component, and/or to determine at least one of the at least one cycle time as the duration of at least one of the individual steps. The latter means in particular that the cycle time recording means is configured to determine at least one cycle time as a time period between two successive different control signals, in particular readiness and/or trigger signals, which delimit at least one individual step, during an action cycle. It is therefore proposed to use readiness and/or trigger signals used in the control device in any case for at least a portion of cycle times to be determined. That means that, in this respect, at least one of the at least one cycle time recording means can be designed, for example as a recording unit of the control device, to monitor control signals exchanged within the control device, in particular readiness and/or trigger signals, and to record, in particular log, the corresponding time when a control signal to be logged occurs. The difference between two such successive times then yields a cycle time, in particular as the duration of an individual step. In other words and put more generally, provision can be made for cycles of the manufacturing plant, i.e. standard sequences, to be defined as time segments with a start time logged when a control signal is present and an end time logged when a further control signal is present. These time segments, i.e. total-cycle cycle times, are then subdivided even further into individual steps which likewise have, preferably exclusively, start times and end times which are defined by the presence of control signals and which are to be logged. The cycle times recorded in this way are then evaluated in a superordinate controller. In this case, it is also possible particularly advantageously for the sum of all individual-step cycle times of a cycle to be provided as a total-cycle cycle time, which will be discussed in even more detail below. The division into individual steps and the recording, in particular logging, of cycle times for the individual steps enable a more accurate analysis as to where the anomaly is present. The individual steps are expediently defined in such a way that deviations from an expected cycle time, in particular for a recipe, can already be assigned to specific anomalies in the context of the evaluation. If, for example, an individual step is defined in which the electronic component is picked from a blister pack in order to be placed on the first laminate layer, typical deviations can occur as a result of poorly positioned blister packs and/or blister packs which are not or not completely opened. Conveying sections may, possibly, over a longer period of time, be associated with a poor grip of the conveying individual-step component and/or with material slipping back, and the like. It should also be pointed out at this juncture that individual-step components may not necessarily be assigned to a single individual step, rather it is entirely conceivable for an individual-step component to carry out a plurality of individual steps and/or to be involved in a plurality of individual steps. An example of this is a gripper device which can both fix the material for the cut and subsequently grip it for removal. Furthermore, it should also be noted in general that in some cases individual-step components of other manufacturing components can also participate in a cycle of a manufacturing component and/or can supply or receive control signals. Consequently, the control signals need not necessarily originate from and/or be directed to the manufacturing component to be monitored.

Preferably, therefore, in the case of at least one cycle time related to at least one individual step, the monitoring unit can be configured to assign an anomaly to at least one individual step and/or at least one measure condition can be formulated for indicating an anomaly to be assigned to at least one individual step upon fulfilment. In this case, however, it is quite possible to use more complex evaluations and/or measure conditions which, for example, may also take into account other individual steps of their cycle (and/or of an adjacent cycle) and the cycle times thereof, since anomalies in specific individual steps may also have effects on the cycle times of other individual steps. Measure conditions can be formulated at least partly in a targeted manner such that they are directed at the detection of anomalies in specific individual steps and/or individual-step components.

In this case, particularly advantageously, a hierarchy of the evaluation processes and/or measure conditions is also conceivable, wherein the superordinate evaluation processes and/or measure conditions relate to the total-cycle cycle time. In this regard, for example, provision can be made for firstly evaluating a measure condition which is related to the total-cycle cycle time and which indicates the presence of an anomaly upon fulfilment, wherein, upon fulfilment of the measure condition, subordinate measure conditions related to individual-step cycle times are evaluated in order to localize the anomaly in at least one individual step and/or one individual-step component—if possible. It should be pointed out here that this hierarchy can also be continued further, for example total times can be determined and can be evaluated for a plurality of successive cycles, for example entire manufacturing components or groups of manufacturing components. By way of example, a total time over all manufacturing components is also conceivable and recordable, wherein in the event of an anomaly in this a transition can then be made in the hierarchy step by step to subordinate total times, in particular total-cycle cycle times, and then to individual-step cycle times.

Exemplary embodiments can provide for at least one of the at least one readiness and/or trigger signal to be a completion signal from at least one supporting and/or positioning individual-step component, in particular a gripper device and/or a pick-and-place device and/or a positioning device, to a material-conveying and/or material-processing individual-step component, in particular a conveyor belt and/or a gripper device and/or a cutting means and/or a material-adding means, and/or to be a start signal for an individual-step component. Other examples of control signals that can be recorded in order to determine cycle times also comprise start signals of the control device and/or of another manufacturing component for the basic start of the cycle.

In a preferred configuration, at least one of the at least one measure condition can be a learning value condition which compares at least one of the at least one cycle time with an assigned upper limit value and/or an assigned lower limit value. For fulfilment of the measure condition, an overshoot is necessary in the case of the upper limit value, and an undershoot in the case of the lower limit value. A check is thus made here to establish whether the cycle time lies within at least one expected limit. Various procedures are conceivable here in order to arrive at the limit values.

In this regard, in a first configuration variant of the present invention, provision can be made for at least one of the at least one limit value, in particular for at least one recipe, to be fixedly predefined. In this case, a comparison with permanently stored limit values is thus made in order to indicate anomalies. Such limit values can be for example limits which are set or determined theoretically during the design of the manufacturing plant, in particular for the respective recipe, and/or during test runs, in particular test runs on the part of the manufacturer. Such intervals in which the cycle time is intended to range are usually chosen to be somewhat wider, since local and/or current particularities cannot be taken into account. They are thus particularly suitable if empirical values are not yet available at the specific manufacturing plant, for example for the specific recipe.

In a second configuration variant, provision can additionally or alternatively be made for the monitoring device to have a determining unit for determining at least one learned limit value from among the at least one limit value in a learning phase of the current manufacturing process and/or of a reference manufacturing process with at least the same recipe. Provision can thus be made for the at least one limit value to be determined, thus as it were learned, in at least one manufacturing process at the same manufacturing plant. Specifically, provision can be made for the learning phase for at least one learned limit value to be a sliding time window ending at the current time or at a predefined temporal distance before the current time and/or the learning phase for at least one learned limit value to be a time segment, beginning in particular after a start-up phase, at the beginning of the current manufacturing process or of the reference manufacturing process and/or a, at least after the start-up phase, complete reference manufacturing process, in particular the first of a recipe. For example, during the first pass of a manufacturing process for a recipe, if as yet no limit value or only the fixedly predefined limit value mentioned above is present, it is thus possible to monitor the scope within which cycle times range during a normally proceeding manufacturing process. In principle, it is preferred here to wait during a start-up phase, for example a specific number of cycles, in particular 5 to 30, in which, in particular with monitoring by a user, the manufacturing plant must run continuously before the stable, normal manufacturing state has been reached and can be used to learn limit values. In principle, such a start-up phase can also be set before the beginning of the monitoring.

Expediently, however, the limit values can keep on being updated as long as the manufacturing plant runs in a stable manner. In this way, improvements, readjustments and the like brought about by the user, for example, can also be taken into account. Nevertheless, a certain temporal distance from the current time should then expediently be maintained, since some anomalies may form slowly and might therefore possibly be “concomitantly learned”, which can be avoided by the temporal distance. For example, the learning phase can always reach back to the end of the last successfully completed manufacturing process. It is particularly advantageous, in the learning phase, too, for the cycle times to be expediently recorded together with at least one, in particular the at least one, further manufacturing value in order to be able to relate them to the manufacturing conditions and other circumstances. In other words, the cycle times are preferably recorded, in particular also during the monitoring, in conjunction with all movements and sensor interrogations at the manufacturing plant. In this regard, especially if the measure conditions also interrogate manufacturing values, further improved and more accurate evaluations can be carried out. In general as well, however, a significant improvement in monitoring is already achieved by learning from preceding manufacturing sections, in particular of the same recipe, since it is possible to focus specifically on the normal state at a specific manufacturing plant.

Monitoring can indeed also be provided during a learning phase, that is to say that, while the at least one learned limit value is being determined, for example currently recorded cycle times can also be monitored with regard to the predefined limit values according to the first configuration variant and/or measure conditions provided in some other way. By way of example, it is conceivable, in the case of a new recipe for which the at least one limit value is intended to be learned, to use measure conditions of a similar recipe, in particular of the most similar recipe, for which purpose a comparison hierarchy can be defined. If, for example, the desired width and/or length of the laminate component to be produced differs only marginally from that of the current recipe, a high similarity can be assumed. Measure conditions of similar recipes can optionally be modified, for example can be attenuated as a function of a similarity measure with decreasing similarity. It goes without saying that if, for example owing to the use of a sliding time window, limit values are updated, the previous limit values are, of course, in principle used for monitoring.

It should also be noted that it is advantageous in principle to analyze a profile of the cycle times over an evaluation time window. For example, a drift of cycle times over time may also indicate an anomaly. A trend that arises over an evaluation time window may indicate increasing wear or the like. Accordingly, measure conditions and possibly further evaluation processes can be configured to evaluate not just the current value of the cycle time but rather the profile over an evaluation time window, which can also be different from measure condition to measure condition.

Generally speaking, the recorded cycle times can also be evaluated in a useful manner over and above the detection of anomalies currently present. In this regard, one preferred configuration of the present invention can provide for the monitoring device furthermore to have an evaluation unit configured to evaluate recorded cycle times stored in a storage means of the monitoring device over at least one time period, in particular the profile of said cycle times, for determining optimized operating parameters of the manufacturing plant and/or for scheduling predictive maintenance. That means that the evaluation of the cycle times, in particular together with at least one manufacturing value, can also be used to improve, in particular optimize, the manufacturing process, since cycle times can also describe improvement potential besides anomalies. In addition, the cycle times, in particular trends in their temporal profile, can also be evaluated in respect of when maintenance might be expedient in the future, which maintenance can then be scheduled at an early stage without the possible occurrence of an (unplanned) outage of the manufacturing plant. Overall, in this way the cycle times are also supplied for further purposes, and thus used to afford multiple advantages. By way of example, it is possible to use in the evaluation unit, in a manner comparable with the measure conditions for anomalies, optimization conditions and/or maintenance conditions which can be assigned corresponding optimization and/or output measures for adapting (settable) operating parameters and/or for indicating maintenance to be scheduled.

In one development, the manufacturing plant can furthermore comprise a display device, in particular as part of the operating device, and the control device can be configured to at least partially output the at least one cycle time and/or information derived therefrom on the display device, in particular within a user interface for operating and monitoring the manufacturing plant. Specifically, provision can be made for example for the outputting to comprise displaying the current cycle time with at least one comparison value, in particular the upper and/or the lower limit value. Furthermore, the displaying can also comprise a profile of the cycle times, in particular also over a plurality of manufacturing processes as a respective average value. In this way, a user can also observe and monitor the cycle times and draw conclusions which may not or not yet be covered by measure conditions and/or the further evaluation, for example for optimization. In addition, said user continuously obtains an overview of the manufacturing plant and the extent to which the manufacturing process is proceeding within normal parameters.

As is generally known for generic manufacturing plants for laminate components, the manufacturing plant according to the invention can preferably also provide for the manufacturing components to comprise
a first feed device for feeding a lower, tape-like first laminate layer and a transport means receiving the first laminate layer,
a placement device, in particular a pick-and-place device, for placing individual components onto the first laminate layer, which is moved in a conveying direction by way of the transport means, at defined intervals,
a second feed device for feeding an upper, tape-like second laminate layer and placing the second laminate layer onto the first laminate layer, with the components being embedded so as to form a laminate tape,
a cutting device comprising at least one movable cutting blade for cutting off individual strip-like laminate components from the laminate tape conveyed by way of the transport means, and
a gripper device for picking up and transporting away the individual laminate components.

For example, as described in DE 10 2022 124 337 A1 mentioned at the outset, provision can be made specifically for the gripper device to be designed to grip the front end of the laminate tape in the area of a component and to be movable in sync with the transport means, which can be moved in a clocked manner, by a predefined distance for moving the laminate tape through the cutting device and positioning the laminate tape relative to the cutting blade. If, in this case, the actual position of the component in the laminate component in relation to the conveying direction is detected by means of a measuring device connected downstream of the cutting device and if, when a deviation of the actual position from a defined target position is detected, the synchronous movement of the transport means and of the gripper device is controlled on the basis of the detected deviation, provision can be made for this detected deviation to also be taken into account in the evaluation of the cycle times, in particular if target values, in particular the expected interval, for cycle times can vary during control on the basis of the detected deviation. In other words, at least one of the at least one limit value can be adapted on the basis of the deviation.

Such an interplay with control mechanisms can also be provided in general, insofar as the compensation of control deviations can influence expected cycle times. In this regard, for example, provision can be made for at least one of the at least one measure condition to be adapted depending on a control deviation of at least one control loop of the manufacturing plant. The type of adaptation, for example of the upper and lower limit values, can be ascertained empirically, for example, by virtue of the cycle times in the case of control deviations being recorded and evaluated in a manner assigned thereto, for example in the learning phase.

Returning to the specific configuration of the manufacturing plant, it can of course also comprise further, optional manufacturing components. In a particularly expedient manner, provision may be made for a testing device for testing the functionality of the electronic component of the laminate component to be tested as a manufacturing component.

It has proved to be particularly advantageous if at least the placement device and/or the transport means and/or the cutting device and/or the gripper device are/is a manufacturing component to be monitored. In this case, for example, the placement device and the transport means and/or the cutting device and the gripper device can also form part of at least one group of manufacturing components to be monitored in each case, since they cooperate closely. For example, in the case of the placement device and the transport means, a plurality of individual steps succeed one another and can each use readiness or other trigger signals and may indicate specific anomalies at many different points, if the individual steps of the cycle through which the group pass(es) are all correspondingly monitored by cycle times. A similar interplay results for the gripper device and the cutting device. Synchronicity and its maintenance can also be checked by looking at cycle times together within such a group. By way of example, the following time stamps, which can describe a start time or end time of individual steps, can be recorded for the placement device, embodied as a pick-and-place device. In one example, a readiness signal indicating that the last component has been placed and a pick-up of the placement device is in a raised (“up”) readiness position can first be recorded in a placement device. A feeder then moves the component, for example a chip, into a removal position. The conclusion of this individual step, after which the electronic component is ready to be picked up, is recorded as the end time of this first individual step, which is also the start time for the second individual step, since the placement device is now triggered to move the pick-up over the removal position. Once this has been reached, this is also logged as a time. The third individual step of lowering the pick-up into a lowered (“down”) position until it is ready to pick up is then carried out. The reaching thereof is also logged. In the fourth individual step, the electronic component is picked up at the removal position, for example from a blister, and the pick-up moves into the raised position again. The end time is also recorded for this fourth individual step. Then, in a fifth individual step, the transport means or a corresponding individual-step component of the transport means moves the lower laminate layer into a placement position. Once this has been reached, a readiness signal is output and logged and in turn also serves as a trigger signal for the placement device which moves the pick-up over the placement position as a sixth individual step. The reaching of this position is recorded as the end time of the sixth individual step and as the start time of the seventh individual step, in which the pick-up is lowered and places the component on the lower laminate layer at the placement position. The completion of this process is again recorded by means of a corresponding completion signal, after which, in the final, eighth individual step, the pick-up returns into the raised readiness position. The initial readiness signal is now reached again and the next cycle can begin. This division into individual steps is exemplary, since finer and coarser divisions can also be expedient.

All of these control signals indicating triggers, a completion or a readiness and the like can be recorded by the cycle time recording means, for example a recording unit of the control device, wherein the corresponding time stamp describing a start time or end time of an individual step is logged (time stamp). The cycle times are obtained on the basis of the differences, the total-cycle cycle time also being obtained as the difference between the first start time and the last end time. Exemplary anomalies which can be detected by way of these cycle times, optionally together with at least one manufacturing value, on the basis of measure conditions comprise
incorrect provision by the feeder, for example empty blister pack or twisted component
pick-up loses the component
incorrect component placement on the lower laminate layer
wear on the axles of the pick-up
necessary correction for setting the pick-up
incorrect feeding of the first laminate layer
material slips back
wear on the conveying means
user input errors in operating parameters such as movement parameters, for example speeds of the placement device and/or of the feeder and/or of the first feed device and/or of the transport device, and/or properties, for example dimensions, of the electronic component to be gripped,
the pick-up system of the placement device is dirty.

Of course, other possibilities are also conceivable. The insights concerning wear can also be processed and/or obtained in the evaluation unit with regard to maintenance, for example by way of the maintenance condition.

The cycle time analysis is not limited to a manufacturing component. For example, as already indicated, it is particularly advantageous if cycle times of the cutting device are also recorded in parallel with the gripper device, wherein at least one measure condition in each case evaluates at least one cycle time of the gripper device and of the cutting device jointly in order to ascertain a specific anomaly and/or at least one cycle time of the cutting device is determined on the basis of at least one control signal also used to determine a cycle time of the gripper device. Some control signals which have been used for defining individual steps and associated cycle times with respect to the gripper device can likewise be used for the cutting device. In the case of the optional testing device, too, different cycle times can be logged, for example the arrival of the material, the use of sensor systems and test devices and the like. It should also be noted that, even if the cycle as a whole relates to an action on the material, i.e. tape, not every individual step need act directly on the material. In general, the following processes are suitable for recording cycle times:
strip unwinding (material feed of the upper and lower laminate layers)
provision of the component by the feeder
transport processes
separation at the cutting device
handling of the finished laminate component (gripping, lifting device, turning, etc.)
inspection of the finished laminate component (quality inspection, inspection with camera and reader)
winding of the finished laminate components.

In these further processes, the following further faults can also be identified, for example, on the basis of the cycle times:
problems in the strip feed (material jam, material tear and the like)
errors in component monitoring or component inspection (e.g. if the electronic component is present, it is functional)
material shrinkage at the cutting device (effect on clocking)
incorrect positions at the cutting position and/or at other positions, in particular transfer points,
errors in the transfer between manufacturing components and/or single-step components (check of cooperation).

In addition to the manufacturing plant, the present invention also relates to a computer-implemented method for monitoring the operation of a manufacturing plant for producing separated strip-like laminate components containing an electronic component embedded between two laminate layers of a tape-like material, wherein the manufacturing plant has a plurality of material-processing and/or material-conveying manufacturing components which can be controlled on the basis of operating parameters, a control device for controlling the manufacturing components, and an operating device, wherein the control device has a monitoring device for monitoring the operation of at least one manufacturing component to be monitored from among the manufacturing components, comprising at least one individual-step component for carrying out individual steps of a cycle for acting on the material. According to the invention, the method has the following steps during a manufacturing process:
recording a cycle time of the cycle on the at least one manufacturing component to be monitored, by way of at least one cycle time recording means,
evaluating cycle times recorded by the cycle time recording means with regard to the fulfilment of at least one measure condition which indicates the presence of an anomaly in the manufacturing process, and
carrying out at least one control measure which is assigned to a fulfilled measure condition and relates to an output of an indication of the presence of the corresponding anomaly and/or an intervention in the manufacturing process related to the anomaly.

All statements with regard to the manufacturing plant according to the invention can be analogously applied to the method according to the invention, and vice versa, and so the advantages already mentioned can also be obtained with the method.

A computer program according to the invention can be loaded directly into a storage means of a control device of a manufacturing plant for producing separated strip-like laminate components containing an electronic component embedded between two laminate layers of a tape-like material and has program means such that, when the computer program is executed on the control device, the latter is prompted to carry out the steps of a method according to the invention. The computer program can be stored on an electronically readable data carrier according to the invention, which thus comprises control information stored thereon, which control information comprises at least one computer program according to the invention and is configured in such a way that, when the data carrier is used in a control device of a manufacturing plant for producing separated strip-like laminate components containing an electronic component embedded between two laminate layers of a tape-like material, said control information is designed to carry out a method according to the invention. The data carrier can be a non-transient data carrier, for example a CD-ROM.

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

### BRIEF DESCRIPTION OF THE DRAWING

In the drawings:

FIG. 1 shows a basic side view of manufacturing components of an exemplary embodiment of a manufacturing plant according to the invention for producing separated strip-like laminate components containing an electronic component embedded between two laminate layers of a tape-like material,

FIG. 2 shows the manufacturing plant from FIG. 1 in a top view,

FIG. 3 shows a perspective partial view of the manufacturing plant, illustrating the placement device together with the assigned transport means and the second feed device,

FIG. 4 shows a partial view of the manufacturing plant from FIG. 1, illustrating the cutting device and the gripper device,

FIG. 5 shows control and operating components of the manufacturing plant,

FIG. 6 shows a flowchart of one exemplary embodiment of the method according to the invention,

FIG. 7 schematically shows a first state diagram for explaining the method,

FIG. 8 schematically shows a second state diagram for explaining the method,

FIG. 9 schematically shows a third state diagram for explaining the method,

FIG. 10 schematically shows a fourth state diagram for explaining the method,

FIG. 11 schematically shows a fifth state diagram for explaining the method,

FIG. 12 schematically shows a sixth state diagram for explaining the method,

FIG. 13 schematically shows a seventh state diagram for explaining the method,

FIG. 14 schematically shows an eighth state diagram for explaining the method, and

FIG. 15 shows a possible display in the user interface.

### DETAILED DESCRIPTION OF THE INVENTION

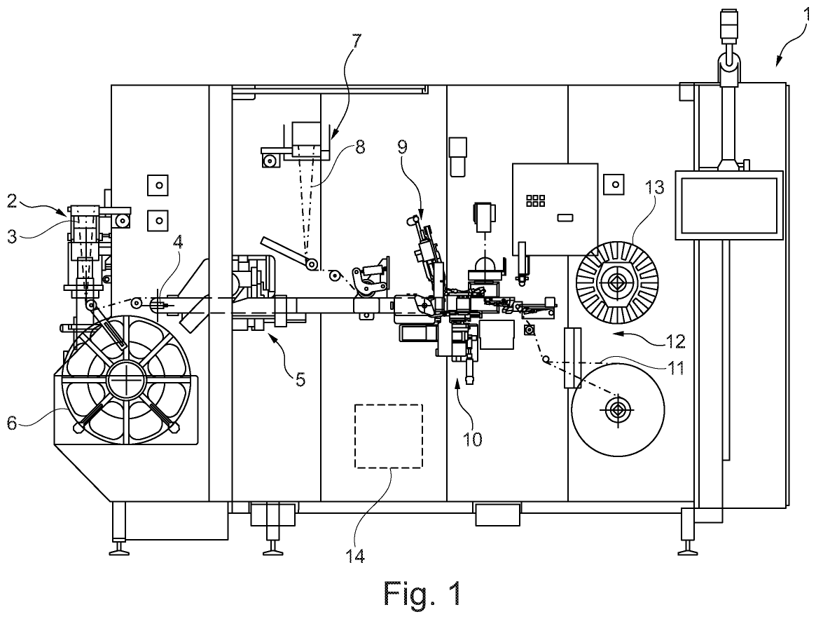

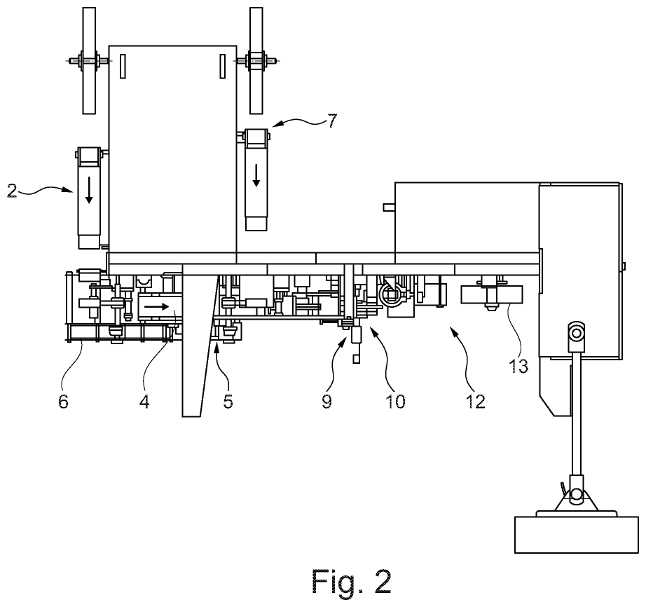

FIG. 1 shows a manufacturing plant 1 according to the invention for producing individual strip-like laminate components which consist of two laminate layers of a tacky material laminated on top of one another, between which laminate layers an electronic component, in the present case an RFID chip, is embedded. The manufacturing plant 1 comprises a first feed device 2 for feeding a lower, tape-like first laminate layer 3 and a transport means 4, for example a conveyor belt or transport belt, onto which the lower, first laminate layer 3 is placed. As FIG. 2 shows, the first feed device 2 is arranged laterally with respect to the transport means 4, that is to say that the first laminate layer 3 is fed at an angle of 90° and is subsequently deflected and placed onto the transport means 4.

Furthermore, a placement device 5 for placing the individual electronic components to be embedded onto the first laminate layer 3 is provided, wherein the individual components, that is to say in the present case the RFID chips, are fed from a supply roll 6 via a feed belt (feeder) and are subsequently gripped and placed in a defined manner via the placement device 5, a pick-and-place device.

Furthermore, a second feed device 7 for feeding an upper, tape-like second laminate layer 8 is provided and, see FIG. 2, is likewise laterally offset with respect to the transport means 4, such that the second laminate layer 8 is also fed at an angle of 90° and is subsequently deflected. The second laminate layer 8 is placed onto the first laminate layer 3, which is already fitted with the components, such that a laminate tape is formed, consisting of the firmly connected two laminate layers 3, 8 and the embedded components.

Also provided is a cutting device 9 comprising at least one movable cutting blade for cutting off individual strip-like laminate components from the laminate tape fed by way of the transport means 4. Connected downstream of the cutting device 9 is a gripper device 10 for picking up and transporting away the individual laminate components, which are finally placed onto a winding tape 11 of a winding apparatus 12, which winding tape 11 is then wound onto a roll 13.

Also shown in principle is a control device 14 which controls the essential components of the manufacturing plant 1, which will be discussed in detail below.

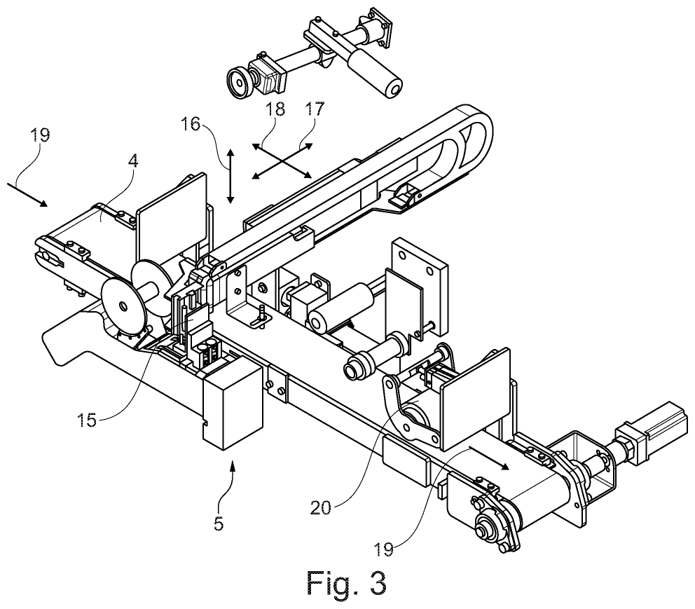

FIG. 3 shows a perspective view of the placement and laminating area of the manufacturing plant 1. The transport means 4, onto which the lower, first laminate layer 3 is placed, is shown. Also shown is the placement device 5 having a suitable pick-up 15 which, as illustrated by the arrow 16, can be moved vertically, on the one hand, and can also be moved horizontally, on the other hand, as illustrated by the arrow 17, after the component feed takes place to the side of the transport means 4 and the component has to be gripped via the pick-up 15, raised and moved over the transport means 4 and lowered again there. Due to the movability of the placement device 5 or its pick-up 15 in the direction of the arrow 17, i.e. transversely to the transport direction, a transverse or lateral correction of the placement position of the component onto the lower, first laminate layer 3 is possible. As illustrated by the arrow 18, the pick-up 15 of the placement device 5 itself is also movable in the conveying direction of the transport means 4, which conveying direction is illustrated by the arrow 19, in order to thereby be able to perform a correction of the placement distance, which takes place in the conveying direction.

Also shown is, inter alia, the actual laminating roller 20, which is arranged above the transport means 4 and below which the upper, second laminating layer is also fed, which is then laminated onto the lower, first lamination layer 3 by means of the laminating roller 20.

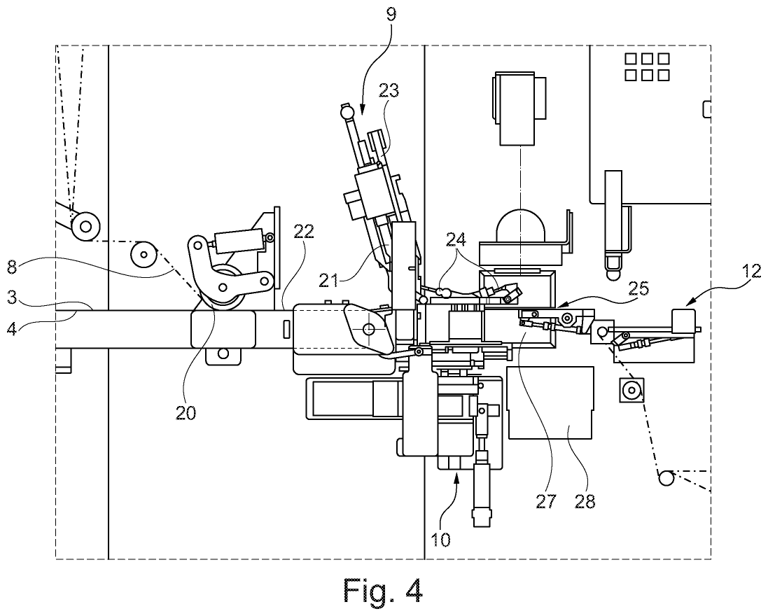

FIG. 4 shows a detailed view of a further area of the apparatus 1, specifically the separation area. The transport means 4 is shown again, and, indicated here, the first lamination layer 3 fitted with components and lying thereon. Also indicated is the second, upper lamination layer 8 which is laminated on via the laminating roller 20.

Connected downstream of the transport means 4, as described, is the cutting device 9 comprising a linearly movable cutting blade 21 which runs transversely to the conveying direction 19 and cuts the laminate tape 22 to form the individual laminate components. The lifting operation of the cutting blade 21 is controlled by means of a suitable lifting device 23 such as a pneumatic cylinder or an electric motor, by means of which the cutting blade 21 moves down exactly at the required time in order to make the cut.

As described, a gripper device 10, in the present case comprising two separate grippers 24, is connected downstream of the cutting device 9. Each gripper 24 is equipped to pick up, lift and transport away a cut laminate component and transfer it to a transfer device 25, from which a previously measured and tested laminate component is transferred to the winding device 12 or discarded.

Also shown is a test device 27 which can be optionally provided and is positioned in the area in which a laminate component is transferred from a gripper 24 to the transfer device 25. The proper functioning of the laminated component, that is to say of the RFID chip, can be checked by means of this test device, wherein such a laminate component is transferred to the winding device 12 only when the component also operates properly. Otherwise, the laminate component is excluded by transfer into a collecting container 28. The test device 27 can be a corresponding reading or transmitting device which, for example, communicates contactlessly with the RFID chip in order to read out its response signals or its identification code etc., wherein the corresponding information can be given to the control device 14 and also stored there.

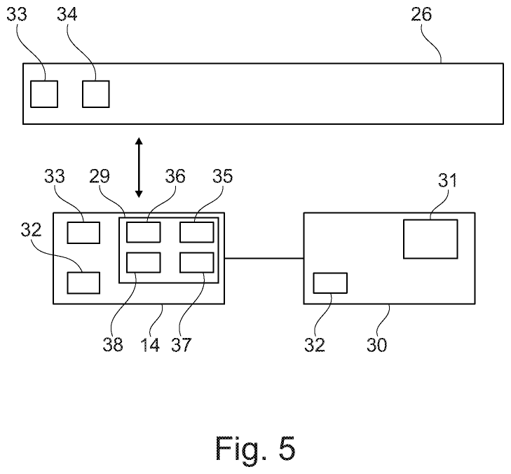

FIG. 5 schematically shows the control, operating and monitoring structure of the manufacturing plant 1. In addition to the arrangement 26 of manufacturing components, the manufacturing plant 1 has the control device 14 which in this case comprises a monitoring device 29 and optionally further components. The operation of the manufacturing components of the arrangement 26 can be controlled via the control device 14. The control device 14 is also connected to an operating device 30, via which user inputs made by a user/an operator can be received. The operating device 30 also has a display device 31, in the present case a display or a screen. It should be noted that a user interface can also be provided via Internet access or the like. The control device 14 and the operating device 30 can be designed to be at least partially integrated, that is to say that components of the control device 14 can be installed in structural units or assemblies of the operating device 30, and vice versa.

The control device 14 and/or the operating device 30 furthermore comprise(s) a storage means 32, in which, in addition to other information, operating parameters (or specifically the values thereof), cycle times and manufacturing values (which can at least partly correspond to values of operating parameters) and measure conditions can also be stored in the present case. In this respect, it should first be noted that a manufacturing process for producing a specific manufacturing product is usually based on what is known as a recipe, which comprises default parameters describing the manufacturing product (for example a width of the laminate component, a general material specification and/or a type of electronic component) and possibly further operating parameters, for example an output to be achieved. The operating parameters described by the recipe of the current manufacturing process usually cannot be changed during the manufacturing process. By way of example, they can be entered on the operating device 30 and/or read out from a data carrier and/or server.

In the context of a manufacturing process carried out for the implementation of a specific recipe, there are also settable operating parameters, i.e. for example operating parameters that can be chosen by the user. Settable operating parameters can be adapted automatically during operation by the control device 14, for example by way of closed-loop control operations, but also at least in part by the operator by way of the operating device 30. Changes to the operating parameters, for example starting from a base set for a recipe, are in principle used to optimize the manufacturing process or the manufacturing product.

The control device 14 and its control mode are superordinate, i.e. encompass all manufacturing components of the arrangement 26. At least one of the settable operating parameters concerns multiple or even all manufacturing components, for example a conveying speed of the laminate material through the arrangement 26.

The monitoring device 29 serves to monitor the operation of the manufacturing plant 1 during a manufacturing process according to a specific recipe. It uses, as input data, cycle times recorded by at least one cycle time recording means 33 for at least one manufacturing component to be monitored, wherein in the present case at least the placement device 5, the transport means 4, the cutting device 9 and the gripper device 10 are manufacturing components to be monitored. Further manufacturing components, for example the feed devices 2, 7, the feeder (if not in any case formed as part of the placement device 5), the test device 27 and the like, can of course also be monitored.

In the exemplary embodiments discussed in more detail here, the cycle time recording means 33 is formed by a recording unit of the control device 14 and interrogates control signals, for example readiness signals, trigger signals and the like, from manufacturing components and/or their individual-step components, the time stamp of which describes the start times and/or end times of cycle times. Start times and/or end times can also be recorded at least in part by cycle time recording means 33 of the arrangement 26 itself, for example sensors and/or other transducers.

In this context, it should already be noted that manufacturing components run through a repeating respective cycle during the manufacturing process; for example, the placement device 5 repeatedly ensures that electronic components are placed on the lower laminate layer 3, the cutting device 9 repeatedly separates laminate components, the gripper device 10 picks them up and transports them and the checking device 27 tests them. These cycles are each formed by individual steps, wherein in the present case a cycle time is determined for each of these individual steps. That means that the sum of the cycle times of the individual steps (individual-step cycle times) corresponds to the total-cycle cycle time, i.e. the duration of a cycle. In this case, the individual steps are carried out in particular by individual-step components of the manufacturing components, for example the transport means 4 and the placement device 5. For example, a feeder and a pick-up can be assigned as a single-step component to the placement device 5 in the form of a pick-and-place device, and a conveyor belt can be assigned as a single-step component to the transport means 4. The assignment can be effected functionally or structurally, wherein the manufacturing component to which an individual-step component is assigned is ultimately not relevant to the control structure and procedure according to the invention.

Optionally, in addition to the cycle time recording means 33, further recording means 34 can also be provided and are designed to record at least one manufacturing value which is to be evaluated together with at least one of the cycle times. Manufacturing values can be for example operating parameters that are present or used in the control device 14, but can also describe manufacturing circumstances recorded by sensors, for example temperatures, movements and positions of the material, processing conditions (for example a temperature) and the like.

In order to be able to evaluate the recorded cycle times, the monitoring device 29 of the control device 14 in the present case firstly comprises a monitoring unit 35. The monitoring unit 35 checks the fulfilment of measure conditions which each evaluate at least one cycle time and, upon fulfilment, indicate the presence of an anomaly in the manufacturing process. In this case, each measure condition is assigned at least one control measure which is performed by a measure unit 36 of the monitoring device 29 upon fulfilment of the measure condition. The at least one control measure can relate for example to the output of an indication of the presence of the corresponding anomaly, for example a warning indication, but also an intervention in the manufacturing process related to the anomaly, for example the adaptation of a settable operating parameter, the omission of an optional individual step or, in extreme cases, an emergency stop, i.e. an at least temporary and/or partial interruption of the manufacturing process.

The monitoring device 29 also allows a further-reaching evaluation of the cycle times in an evaluation unit 37. The latter evaluates the cycle times in respect of whether predictive maintenance is necessary, for which purpose for example at least one maintenance condition, which preferably evaluates a profile of cycle times, can be checked. For example, the presence of at least one drift of at least one cycle time can be checked. Upon fulfilment of the maintenance condition, the predictive maintenance is scheduled. However, the cycle times are also evaluated in the evaluation unit 37 for the purpose of optimizing the manufacturing process, for example for adapting set operating parameters of the current manufacturing process and/or future manufacturing processes of the same recipe.

It should be noted in general that any evaluation in the monitoring device 29 is carried out in a recipe-related manner, that is to say that cycle times, measure conditions and/or maintenance conditions/optimization processes to be recorded are all formulated for a specific recipe.

Specifically, provision can be made here for example for using predefined measure conditions (and optionally evaluation parameters of the evaluation unit 37) firstly for a recipe for which as yet no manufacturing process has been carried out on the manufacturing plant 1, for example on the basis of test runs, other manufacturing plants and/or similar recipes. Since measure conditions can be in particular at least in part limit value conditions which involve comparing at least one of the at least one cycle time to be evaluated with an upper and/or a lower limit value, predefined limit values can describe for example fundamentally expected intervals for specific cycle times.

In the exemplary embodiments described here, however, provision is made for learning the normal sequence of the corresponding manufacturing process, if appropriate also continuously, at the specific manufacturing plant for a specific recipe, in order to be able to detect anomalies particularly accurately, reliably and robustly. For this purpose, in a learning phase—optionally with parallel monitoring on the basis of the predefined measure conditions—the cycle times, optionally with the respective manufacturing values, are recorded. The learning phase can comprise for example at least one part of a reference manufacturing process which begins after a start-up phase, optionally the entire first manufacturing process of a specific recipe (without a start-up phase). By way of example, the beginning of the learning phase may necessitate that at least a predetermined number of cycles have been run through without termination/restart, in particular at least ten laminate components have been successfully produced without termination.

However, a sliding time window as a learning phase is also conceivable in the case of continuous learning, although a predefined temporal distance from the current time should be maintained in order to avoid learning drifts that indicate an anomaly. By way of example, after confirmation that that has proceeded normally, the preceding manufacturing process of the same recipe can always be evaluated in order to determine or update the suitable measure conditions, in particular the limit values. It should be noted that if limit values are used, these may be dependent for example on a manufacturing value that is likewise to be evaluated by way of the respective measure condition. The determination of measure conditions in general and limit values in particular can be carried out by a determining unit 38 of the monitoring device 29.

Expediently, measure conditions can be formulated in such a way that a specific conclusion is also obtained which describes the detected anomaly in more detail. That means that, in the case of specific deviations/violated limit values, it is possible for example to deduce specific errors or other anomalies more accurately. This is possible in an expedient and more detailed manner in particular on the basis of the division of the cycle into individual steps and the determination of cycle times for these individual steps. It may also be expedient to organize measure conditions hierarchically, for example firstly to check, for the total-cycle cycle time, whether the presence of an anomaly is generally indicated, following which subordinate measure conditions seek to classify or localize this anomaly more accurately.

It should also be noted that, even in general terms, particular advantages may be afforded if, at least for manufacturing components which have cycles proceeding at least partly in parallel and/or which interact functionally, at least one measure condition also evaluates at least one cycle time of each of the two manufacturing components, since this can contribute to an even more accurate assignment and/or classification of a detected anomaly. This can relate, for example, to the transport means 4 and the placement device 5 or else to the gripper device 10 and the cutting device 9. A joint consideration of cycle times on more than two manufacturing components is also conceivable. In addition, it should be pointed out that for the purposes of the integration already mentioned, for example the units 33, 35 and optionally 36, 37 and 38 can be implemented in a structural unit or assembly which is assigned to the operating device 30 and can contain the display device 31, for example.

One exemplary embodiment of the method according to the invention for monitoring the operation of the manufacturing plant 1 will now be discussed below, focus being placed on the placement device 5 which can also use individual-step components of the transport means 4, for which possible individual steps are illustrated purely by way of example. Of course, it is also possible in this respect to apply a wide variety of modifications, known in principle in the prior art, with regard to the construction of the placement device 5 and the specific individual steps. In other words, the specific example presented here should be understood to be purely illustrative.

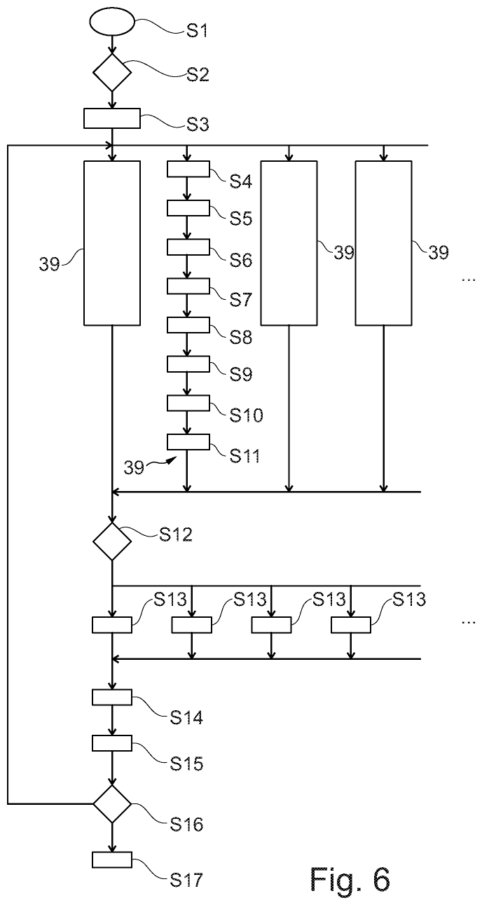

As shown in FIG. 6, in a step S1 a new manufacturing process begins for a specific recipe, which is also correspondingly logged, i.e. in particular stored in the storage means 32. In the present case, it is assumed that measure conditions, in particular learned limit values, are already present for this recipe.

In a step S2, a check is then made to establish whether the manufacturing plant 1 is running in a stable manner, and hence a start-up phase is completed. For this purpose, it is necessary that ten cycles have been run through without interruption, i.e. in particular ten laminate components have been produced without interruption.

If this is the case, the monitoring, i.e. in particular also the recording and evaluation of cycle times, is enabled in a step S3. If ten splices without interruption is not accomplished, the method is begun again anew until this is accomplished.

Thus, in what follows then the cycle times are recorded by means of the cycle recording means 33 and manufacturing values are recorded in parallel by means of the further recording means 34. This is shown in more specific detail only by way of corresponding steps S4 to S10 for the placement device 5, and otherwise abstracted by way of step blocks 39 for the sake of simplicity. Step blocks 39 are additionally provided in the present case at least for the feed devices 2, 7, the cutting device 9 and the gripper device 10 as well as the checking device 27, preferably also for further manufacturing components.

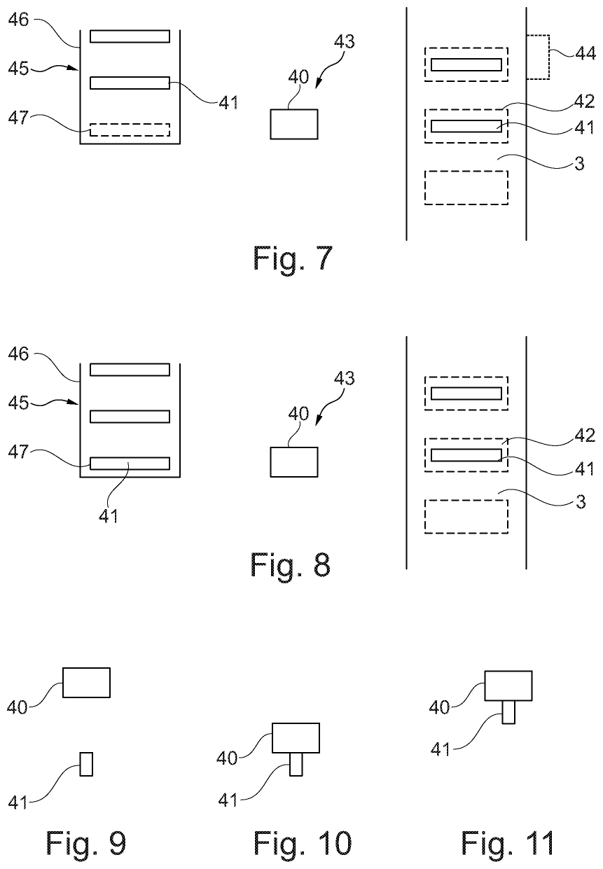

FIG. 7 schematically shows first of all the general situation at the placement device 5 at the beginning of a cycle, wherein, for reasons of clarity, a pick-up 40 is shown as a single-step component 43 of the placement device 5 centrally, covering no other components, although it is usually shown at this time above the placement position 42 of the lower laminate layer 3 (now occupied by an electronic component 41, here an RFID chip). A single-step component 44, for example a conveyor belt, of the transport means 4 for conveying the lower laminate layer 3 is indicated only schematically for the sake of clarity.

On the left-hand side, a feeder 46 is shown as a further single-step component 45 and can provide further components 41 from the feed roller 6 at a currently empty removal position 47.

In a step S4 in the step block 39 for the placement device 5, a general start signal/trigger signal is firstly recorded and, for each cycle after the first cycle, can indicate for example that the pick-up 40 (after placing the last electronic component 41 at the placement position 42) has arrived at a readiness position above the placement position 42, and the time stamp thereof is logged as the start time of the first individual-step cycle time. The state at this starting time is schematically explained in more detail by way of FIG. 7, except for the pick-up 40 located centrally for the sake of clarity.

The general start signal instructs the feeder 46 as a trigger signal to provide a new electronic component 41 at the removal position 47. Once this has taken place, the feeder sends a completion signal or readiness signal, the time stamp of which is stored, in a step S5, as the end time of the first individual step and the start time of the second individual step once again by the cycle time recording means 33, in particular the recording unit. At this time, the first cycle time for the first individual step can already be provided in principle.

The corresponding state is once again shown purely schematically and abstractly in FIG. 8, where an electronic component 41 is now at the removal position 47.

The readiness signal from the feeder 46 is considered to be a trigger signal for the pick-up 40 in order to move into a position above the removal position 47. Once this has taken place as a second individual step, a corresponding readiness signal is sent, the time stamp of which is again logged in step S6. The corresponding time forms the end time of the second individual step and the start time of the third individual step.

FIG. 9 illustrates the corresponding state in a schematic side view. The lowerable pick-up 40 is arranged in a position above (“up”) the component 31.

In the third individual step which now follows, the pick-up 40 is positioned in a lowered position directly on the component 41, that is to say in a ready-to-remove position, as indicated in FIG. 10. The time at which the readiness signal “pick-up ready to remove” is present is logged as the end time of the third individual step in step S7 and also serves as the start time for the fourth individual step.

In the fourth individual step, the electronic component 41 is gripped by the pick-up 40, for example removed from a blister pack, and the pick-up 40 moves with the component 41 into the raised position again, as is shown schematically in FIG. 11. The corresponding readiness signal of the individual-step component 43 is stored, in a step S8, as the end of the fourth individual step and the beginning of the fifth individual step.

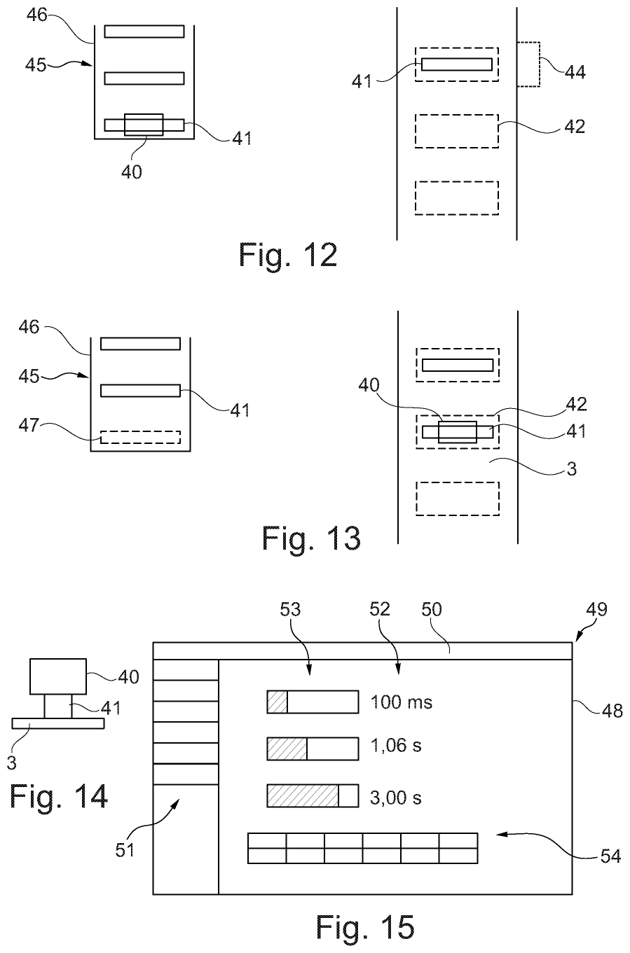

In the fifth individual step, the conveyor belt or the subcomponent 44 of the transport means 4 is then controlled in order to position the next, free placement position 42. The corresponding completion is logged as the end time of the fifth individual step in step S9. The result is shown schematically in FIG. 12. Here, the pick-up 40 with the picked-up component 41 on the left should be understood to be in the raised position according to FIG. 11.

In the sixth individual step, beginning with the readiness signal from the individual-step component 44 of the transport means 4, the movement of the pick-up 40 with the gripped component 41 then takes place over the lower laminate layer 3 and specifically the placement position 42. The completion of this individual step is also communicated as a control signal. The resulting state is shown schematically in FIG. 13. The corresponding control signal is stored in step S10 as the end time of the sixth individual step and the start time of the seventh individual step.

In the seventh individual step, the pick-up 40 is lowered from the upper position into the lower position and the electronic component 41 is placed on the lower laminate layer 3 at the placement position 42. The corresponding situation is indicated in FIG. 14, again schematically in a side view. The control signal indicating the completion of placement is logged in a step S11 and indicates the end of the seventh individual step and the start of the eighth individual step.

In this eighth individual step, the pick-up 40 is again moved into the readiness position, the reaching of which is indicated by the corresponding start signal or readiness signal in step S4 at the beginning of a new cycle. The situation in FIG. 7 arises again.

In a step S12, a check is then made to establish whether there is a sufficient amount of information available for the evaluation, wherein an evaluation can in principle also already take place during a cycle and there need not necessarily be any waiting for the cycle to be completed.

In respective steps S13, the monitoring unit 35 then evaluates the cycle times thus recorded for the various manufacturing components, optionally together with at least one manufacturing value, by way of the measure conditions. In this case, each step S13 can process the measure conditions assigned to a manufacturing component to be monitored. In this case, what has already been stated above concerning the hierarchical structure of the evaluation and concerning the possibility of cycle times of different manufacturing components also being taken into account in individual measure conditions is applicable.

In a step S14, the measures of the fulfilled measure conditions, if present, are then carried out by the measure unit 36. For example, warning indications are output and/or operating parameters of the manufacturing process are adapted.

In step S15, an output takes place on the display device 31, where cycle times and associated information can also be output within a user interface. An exemplary representation 48 of a user interface 49 is shown schematically in FIG. 15. Elements of less relevance to the procedure described here, such as a status bar 50 and a menu 51, will not be discussed in more detail.

For a selected cycle time, for example a cycle time assigned to an individual step or a total-cycle cycle time of a manufacturing component to be monitored, the following are displayed in the upper area of the representation 48 as numbers 52 and bar charts 53 from top to bottom:
the lower limit value, learned in the present case, for the cycle time,
the last recorded, currently present cycle time, and
the upper limit value, learned in the present case, for the cycle time.

It is easily discernible to the operator that the current cycle time, as desired, lies between the lower and upper limit values. It can be displayed green, for example.

In the lower area of the representation 48, a table 54 is presented, which reproduces already recorded cycle times from previous cycles and/or manufacturing processes of the same recipe for further information, for example together with further information such as recording times and the like.

Returning to FIG. 6, a check is made in a step S16 to establish whether the manufacturing process has been completed or whether still further cycles will follow. If still further cycles follow, the method returns to the step blocks 39. However, if the manufacturing process has ended, further evaluations of the recorded cycle times with regard to the optimization of manufacturing processes with the recipe and/or predictive maintenance to be scheduled can be carried out in step S17 by means of the evaluation unit 37, as described. In principle, it is of course also conceivable to carry out such evaluation processes already during a manufacturing process, since it is then possible for example to directly observe the effects of adapted operating parameters on the cycle times and the manufacturing values, for example during optimization, and for example to carry out optimization processes by varying operating parameters.

While specific embodiments of the invention have been shown and described in detail to illustrate the inventive principles, it will be understood that the invention may be embodied otherwise without departing from such principles.

I claim:

1. A manufacturing plant for producing separated strip-like laminate components containing an electronic component embedded between two laminate layers of a tape-like material, in particular a rubberized material, wherein the manufacturing plant has a plurality of material-processing and/or material-conveying manufacturing components which can be controlled on the basis of operating parameters, a control device for controlling the manufacturing components, and an operating device, wherein the control device has a monitoring device for monitoring the operation of at least one manufacturing component to be monitored from among the manufacturing components, comprising at least one individual-step component for carrying out individual steps of a cycle for acting on the material, wherein at least one cycle time recording means for recording a cycle time of the cycle is provided on the manufacturing component to be monitored, and the monitoring device has:
a monitoring unit for evaluating cycle times recorded by the cycle time recording means with regard to the fulfilment of at least one measure condition which indicates the presence of an anomaly in the manufacturing process, and
a measure unit for carrying out at least one control measure which is assigned to a fulfilled measure condition and relates to an output of an indication of the presence of the corresponding anomaly and/or an intervention in the manufacturing process related to the anomaly.

2. The manufacturing plant according to claim 1, wherein at least one further recording means is provided for recording at least one further manufacturing value describing the operation of the manufacturing plant, wherein at least one of the at least one measure condition additionally evaluates at least one of the at least one manufacturing value.

3. The manufacturing plant according to claim 2, wherein at least one of the at least one further manufacturing value relates to a movement and/or a position of the processed material and/or at least one processing condition, in particular a temperature.

4. The manufacturing plant according to claim 1, wherein the recording of the at least one cycle time and the at least one measure condition are related to a recipe-forming set of operating parameters of the manufacturing plant defined for the manufacturing process.

5. The manufacturing plant according to claim 1, wherein the cycle time recording means is configured, for the purpose of recording the cycle time, to interrogate two successive control signals, in particular readiness and/or trigger signals, of at least one of the at least one individual-step component and/or at least one of the at least one manufacturing component, and/or to determine at least one of the at least one cycle time as the duration of at least one of the individual steps.

6. The manufacturing plant according to claim 5, wherein, in the case of at least one cycle time related to at least one individual step, the monitoring unit is configured to assign an anomaly to at least one individual step and/or at least one measure condition is formulated for indicating an anomaly to be assigned to at least one individual step upon fulfilment.

7. The manufacturing plant according to claim 1, wherein at least one of the at least one measure condition is a limit value condition which compares at least one of the at least one cycle time with an assigned upper limit value and/or an assigned lower limit value.

8. The manufacturing plant according to claim 7, wherein at least one of the at least one limit value, in particular for at least one recipe, is fixedly predefined.

9. The manufacturing plant according to claim 7, wherein the monitoring device has a determining unit for determining at least one learned limit value from among the at least one limit value in a learning phase of the current manufacturing process and/or of a reference manufacturing process with at least the same recipe.

10. The manufacturing plant according to claim 9, wherein the learning phase for at least one learned limit value is a sliding time window ending at the current time or at a predefined temporal distance before the current time and/or the learning phase for at least one learned limit value is a time segment, beginning in particular after a start-up phase, at the beginning of the current manufacturing process or of the reference manufacturing process and/or a, at least after the start-up phase, complete reference manufacturing process, in particular the first of a recipe.

11. The manufacturing plant according to claim 1, wherein the monitoring device furthermore has an evaluation unit configured to evaluate recorded cycle times stored in a storage means of the monitoring device over at least one time period, in particular the profile of said cycle times, for determining optimized operating parameters of the manufacturing plant and/or for scheduling predictive maintenance.

12. The manufacturing plant according to claim 1, wherein it furthermore comprises a display device and the control device is configured to at least partially output the at least one cycle time and/or information derived therefrom on the display device, in particular within a user interface for operating and monitoring the manufacturing plant.

13. The manufacturing plant according to claim 12, wherein the outputting comprises displaying the current cycle time with at least one comparison value, in particular the upper and/or the lower limit value.

14. The manufacturing plant according to claim 1, wherein the manufacturing components comprise
a first feed device for feeding a lower, tape-like first laminate layer and a transport means receiving the first laminate layer,
a placement device for placing individual components onto the first laminate layer, which is moved in a conveying direction by way of the transport means, at defined intervals,
a second feed device for feeding an upper, tape-like second laminate layer and placing the second laminate layer onto the first laminate layer, with the components being embedded so as to form a laminate tape,
a cutting device comprising at least one movable cutting blade for cutting off individual strip-like laminate components from the laminate tape conveyed by way of the transport means, and
a gripper device for picking up and transporting away the individual laminate components.

15. The manufacturing plant according to claim 14, wherein at least the placement device and/or the transport means and/or the gripper device and/or the cutting device are/is a manufacturing component to be monitored.

16. A computer-implemented method for monitoring the operation of a manufacturing plant for producing separated strip-like laminate components containing an electronic component embedded between two laminate layers of a tape-like material, in particular a rubberized material, wherein the manufacturing plant has a plurality of material-processing and/or material-conveying manufacturing components which can be controlled on the basis of operating parameters, a control device for controlling the manufacturing components, and an operating device, wherein the control device has a monitoring device for monitoring the operation of at least one manufacturing component to be monitored from among the manufacturing components, comprising at least one individual-step component for carrying out individual steps of a cycle for acting on the material, wherein the method comprises the following steps during a manufacturing process:
recording a cycle time of the cycle on the at least one manufacturing component to be monitored, by way of at least one cycle time recording means,
evaluating cycle times recorded by the cycle time recording means with regard to the fulfilment of at least one measure condition which indicates the presence of an anomaly in the manufacturing process,
carrying out at least one control measure assigned to a fulfilled measure condition, which is assigned to a fulfilled measure condition and relates to an output of an indication of the presence of the corresponding anomaly and/or an intervention in the manufacturing process related to the anomaly.

17. A computer program which, when executed on a control device of a manufacturing plant for producing separated strip-like laminate components containing an electronic component embedded between two laminate layers of a tape-like material, in particular a rubberized material, prompts said control device to carry out the steps of a method according to claim 16.

18. An electronically readable data carrier on which a computer program according to claim 17 is stored.
